(19) United States
(12) Patent Application Publication
(10) Pub. No.: US 2006/0000490 A1
(43) Pub. Date: Jan. 5, 2006

(54) Method and apparatus for cleaning residual material from the dispensing elements of mixing trucks

(76) Inventors: Jorge C. Barragan, Fremont, CA (US); Charles D. Wallis, Tracy, CA (US)

Correspondence Address: JONES, TULLAR & COOPER, P.C., P.O. BOX 2266 EADS STATION, ARLINGTON, VA, 22202, US

(21) Appl. No.: 10/879,705

(22) Filed: Jun. 30, 2004

(51) Int. Cl. B08B 7/04

(52) U.S. Cl. 134/10; 134/104.2

(57) ABSTRACT

An apparatus, system, and method are provided for facilitating the cleaning of residual concrete from the dispensing elements of a truck, such as from the hopper, main chute, and auxiliary chute of a concrete mixing truck. The apparatus of the invention includes a catch basin that is mounted on and carried by the truck for receiving the runoff resulting from washing the concrete residue from the dispensing elements of the truck. A funnel assembly is mounted on the dispensing chute, and a hose is connected between the funnel assembly and the catch basin. The dispensing elements of the truck are then washed using water or other suitable liquid, and the mixture of liquid and residue passes through the funnel and hose, and into the catch basin. The system may also include a means for supporting and cleaning an auxiliary chute. The runoff received by the catch basin may be emptied at a later time and properly disposed of or recycled.

### BACKGROUND OF THE INVENTION

1. Field of the Invention

The invention relates to a method and apparatus to facilitate cleaning of the dispensing elements of mixing trucks. More specifically, the invention relates to cleaning the hopper and chutes of concrete mixing trucks while retaining the runoff from the cleaning process for proper disposal at a later time.

2. Description of the Related Art

Conventional concrete mixing trucks include large drum containers for mixing aggregate, sand, and cement slurry together to produce pourable concrete at a job site. Typical operation of a concrete mixing truck begins by loading the truck with the materials, usually by depositing the materials into the drum via one or more loading hoppers at the concrete facility. After loading, the drum rotates to mix the materials, and the truck is driven to a construction site where the delivery chute is positioned at a desired location. The chute is placed at a downward angle so that the concrete mixture may flow down and out of the chute. An auxiliary chute, or chute extension may be attached to the end of the main chute to better direct the flow of concrete. The concrete is discharged from the drum, into a truck hopper, and down the chute to the desired discharge location, such as into a concrete pump, a wheelbarrow, or directly onto the area being coated. A residual amount of concrete or a coating thereof may remain on the truck's dispensing elements after the concrete is poured. This concrete or concrete coating may harden on the chutes and hopper, thereby impeding use of the dispensing elements at a later time. In addition, the residual concrete may accidentally fall from the truck while the truck is returning from the construction site. This can create a hazard to drivers following behind the truck, and may form undesirable deposits of concrete on roads or other areas.

Thus, after concrete has been fully discharged from the truck, the operator must wash away the concrete residue adhering to the truck hopper and outlet chutes before leaving the construction site. In order to remove the concrete residue, the hopper and chutes may be washed off at the construction site using a hose and water. A disadvantage of this method is that a concrete patch is formed on the ground at the site where the washing takes place. For this reason, many localities have laws barring this practice. Accordingly, the contractor must provide a designated location at the construction site where this rinsing operation may occur. This may be inconvenient and inefficient, especially if the rinsing station is located at a site remote from the concrete discharge location.

Moreover, concrete truck wash-off can pose serious environmental concerns. Thus, environmentally friendly and cost efficient systems for cleaning the dispensing elements of concrete mixing trucks have become ever more desirable, especially as it becomes increasingly unacceptable to dump the residual concrete outside of a prescribed disposal area. In many cases, precautions must be taken at the construction site to ensure that concrete residue runoff does not contaminate the site or adjoining waterways. Because construction sites are being subjected to ever-increasing environmental regulations, proper disposal of concrete residue will continue to be of concern for the foreseeable future.

Various systems for ridding residual concrete material from mixing trucks have been proposed, including emptying the material into portable containers for remote disposal, and washing the material directly into sewage systems. These methods are undesirable in that they pose various environmental and practical problems. For example, emptying the material into portable containers, such as buckets, for remote disposal, is labor intensive and time consuming. Washing the material directly into a sewage system causes environmental and other problems. For example, it can increase the burden on the sewage system and may cause blockage of the system, in addition to being environmentally undesirable. Yet other prior art systems require the use of powered pumps or pressurized containers for returning the runoff material to the drum on the truck. These systems are prohibitive because of the expense in acquiring and maintaining the systems.

Consequently, it would be advantageous to provide an environmentally sound and economically practical method and apparatus that would greatly reduce or eliminate the drawbacks of the prior art systems. It would be particularly desirable if such a method and apparatus were able to recycle any residual material so that it may be recovered and reused. The need has therefore arisen for an improved system for cleaning residual material from concrete trucks and disposing of it properly.

### BRIEF SUMMARY OF THE INVENTION

In a first aspect, the invention is directed to a system, method, and apparatus for facilitating the cleaning of residual material from the dispensing elements of a truck, such as from the hopper, main chute, and auxiliary chute of a mixing truck. The apparatus of the invention includes a catch basin that is mounted on and carried by the truck for receiving the runoff from washing the material residue from the dispensing elements of the truck. A funnel assembly may be mounted on the truck's dispensing chute, and a drain hose is connected between the funnel assembly and the catch basin. The dispensing elements of the truck are then washed using water or other suitable liquid, and the mixture of liquid and residual material passes through the funnel and hose under the force of gravity, and into the catch basin. The apparatus may also include a means for supporting and cleaning an auxiliary chute.

In another aspect, the method of the invention includes: providing a concrete mixing truck with a catch basin; attaching a funnel to the main chute of the truck; connecting a hose between the funnel and the catch basin; and washing the chute with water or other liquid, whereby the water washes the concrete residue from the chute, into the funnel, through the hose, and into the catch basin. If an auxiliary chute also requires cleaning, the method may also include the step of mounting the auxiliary chute on the catch basin and washing the concrete residue from the auxiliary chute into the catch basin. The runoff received by the catch basin may be emptied at a later time and properly disposed of or recycled.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated, wherein:

FIG. 1 is a perspective view illustrating the system, method, and apparatus of the invention;

FIG. 2 illustrates a perspective view of the truck-mounted catch basin and detachable funnel of the invention in transport configuration;

FIG. 3 illustrates a perspective view of the catch basin of the invention with one sidewall partially cut away, the lid open, the funnel removed, and further illustrating the insertion of the auxiliary chute support rods;

FIG. 4 illustrates a top view of the catch basin of the invention, with the lid open 180 degrees to illustrate the auxiliary-chute support rod storage tubes;

FIG. 5 illustrates a side view of the detachable funnel assembly of the invention; and

FIG. 6 illustrates an end view of the detachable funnel of FIG. 5.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural and logical substitutions and changes may be made without departing from the scope of the invention. The following detailed description, therefore, is not to be taken in a limiting sense, and the scope of the invention is defined only by the appended claims, along with the full range of equivalents to which such claims are entitled.

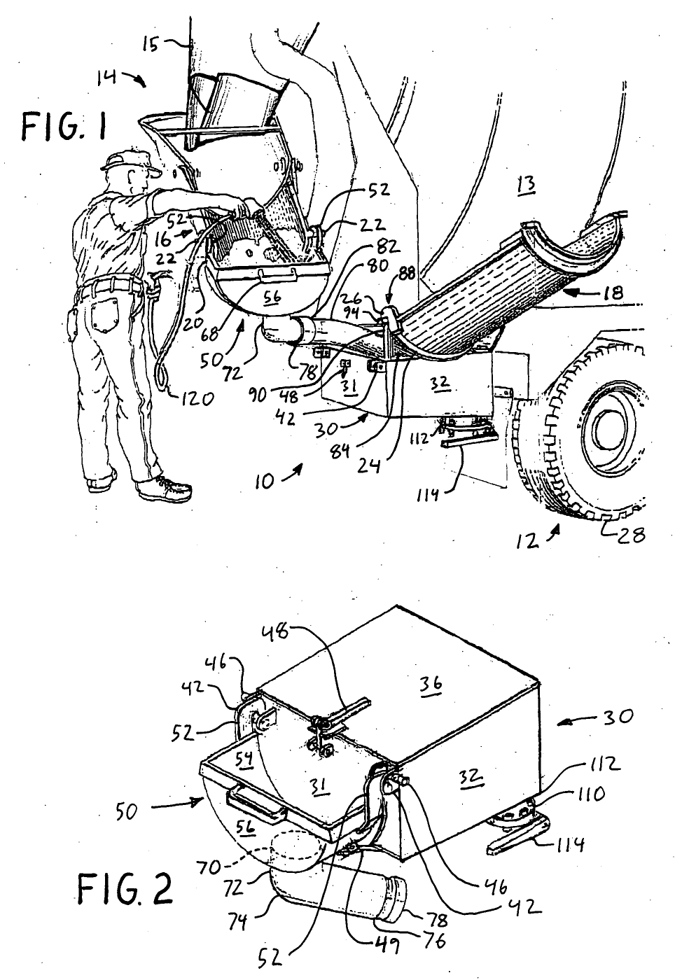

As illustrated in FIG. 1, the method and apparatus of the invention is directed to a system 10 for cleaning residual concrete material from the dispensing elements of concrete trucks following the pouring of concrete, or the like. The system 10 of the invention is mounted on a truck 12 having a mixing drum 13. Truck 12 may be any type of truck that uses a chute for dispensing of materials, but in the preferred embodiment of the invention, truck 12 is a conventional concrete mixing truck having dispensing elements 14, which generally include a hopper 15, a main chute 16, and a detachable auxiliary chute 18. During travel of truck 12 to a job site, auxiliary chute 18 is stored on truck 12 in separate location, detached from main chute 16. Prior to pouring of concrete, auxiliary chute 18 may be attached to the distal free end 20 of main chute 16 to provide better control for directing the flow of concrete exiting mixing drum 13. Free end 20 of main chute 16 includes a pair of chute pins 22 that extend outward from main chute 16 at a right angle to the direction of flow of concrete. A first mating end 24 of auxiliary chute 18 is fitted with a pair of chute-attachment hooks 26 which enable auxiliary chute 18 to be hung on free end 20 of main chute 16 by interfitting hooks 26 with chute pins 22, so that main chute 16 and auxiliary chute 18 form a continuous half-pipe-like surface (not shown) for dispensing of concrete.

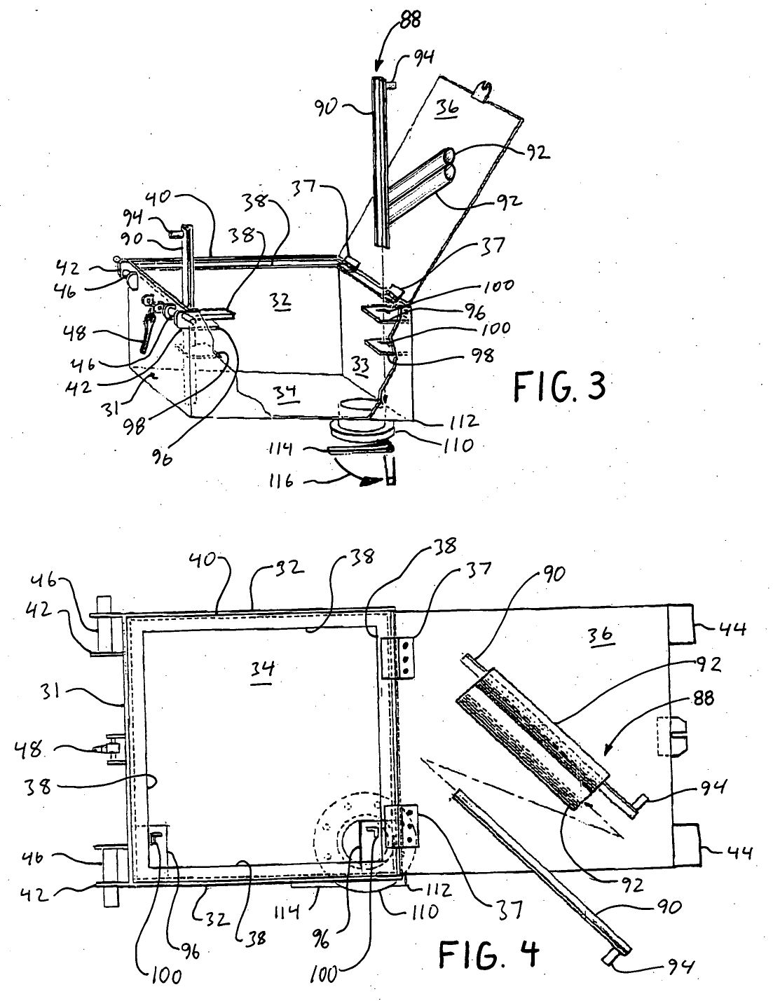

The apparatus of the invention is advantageously mounted on and carried by truck 12, and includes an on-board catch basin 30 that may be mounted on the rear of truck 12 behind the rear tires 28. As also illustrated in FIGS. 2-4, catch basin 30 is a water-tight container or box, which is constructed having a front wall 31, two sidewalls 32, a rear wall 33, and a bottom 34, and is preferably constructed of sheet metal that is folded and welded along mating seams. A lid 36 is attached to basin 30 by hinges 37, and may be opened for providing access to the interior of basin 30, or closed for when truck 12 is in motion. Angle reinforcements 38 are included around the lip 40 of basin 30 to provide reinforcement so that basin 30 is able to support the other components of system 10 and auxiliary chute 18. Angle reinforcements 38 project inward from front wall 31, sidewalls 32, and rear wall 33, and, thereby, help prevent spillage of runoff liquid from within basin 30 while truck 12 is in motion. To further prevent spillage of the runoff during transport, a seal (not shown) may be provided around the upper lip 40 of catch basin 30 for contacting lid 36 when lid 36 is in the closed position, as illustrated in FIG. 3. Catch basin 30 may be either permanently attached to truck 12 by welding, or the like, or may be removably secured to truck 12 by mechanical fasteners or other known means.

Catch basin 30 includes a pair of funnel mounting brackets 42 located near upper lip 40 on the exterior surface of front wall 31. Each funnel mounting bracket 42 projects outward from front wall 31, and includes a horizontally-disposed funnel-support pin 46. As illustrated in FIG. 2, a funnel assembly 50 may be detachably mounted on mounting brackets 42 while the cleaning system 10 of the invention is not in use or ready for transport, so that funnel assembly 50 is supported on the front wall 31 of catch basin 30. This provides a secure storage location for funnel 50 during travel of truck 12 to and from a job site. In addition, catch basin 30 includes a main latch 48 for securing lid 36 during travel mode. A funnel latch 49 may also be provided for securely latching funnel 50 in place during travel mode so funnel 50 does not come loose of mounting brackets 42 when truck 12 goes over a bump, or the like. Alternatively, lid 36 may be extended in the areas 44 over mounting brackets 42 to perform a similar securing function by trapping funnel 50 within mounting brackets 42 (as illustrated only in FIG. 4), and, in this embodiment, only main latch 48 is required for securing the invention for transport.

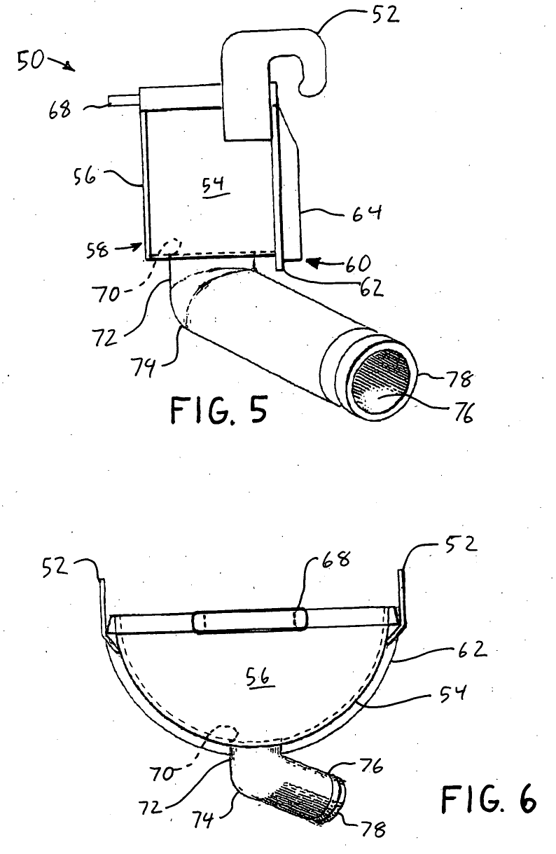

As illustrated in FIGS. 5-6, funnel assembly 50 includes a pair of mounting hooks 52 which enable funnel assembly 50 to be not only detachably mounted on basin 30 during transport, but which also are of a size and configuration similar to chute attachment hooks 26 on auxiliary chute 18. This enables funnel assembly 50 to be mounted on main chute 16, by engaging funnel mounting hooks 52 with chute pins 22, as illustrated in FIG. 1. Thus, funnel assembly 50 can be detachably mounted on free end 20 of main chute 16 for receiving waste cleaning liquid resulting from cleaning of main chute 16.

Funnel assembly 50 includes a semi-cylindrical funnel wall 54 having a semi-circular rear funnel wall 56 welded to one end to create a closed end 58 of funnel 50, and an open, mating end 60 of funnel 50. Semi-cylindrical funnel wall is shaped in a half-pipe configuration of a similar size and shape to match the size and shape of free end 20 of main chute 16, so that cleaning water will flow from main chute 16 into funnel 50. Funnel assembly 50 may be constructed from sheet metal materials, such as stainless steel, steel, aluminum, or other suitable materials.

Mating end 60 of funnel 50 includes a funnel lip 62 formed around the perimeter of semi-cylindrical funnel wall 54, and a gasket 64 is attached around the perimeter of funnel lip 62. Gasket 64 forms a seal with free end 20 of main chute 16 when funnel 50 is mounted on main chute 16 to help prevent leakage of cleaning water onto the ground. Gasket 64 may be constructed of a suitable polymeric or other material such as silicone, vinyl, rubber compounds, and the like, and may be attached to funnel lip 62 by adhesive, mechanical fasteners, or other suitable means.

Funnel mounting hooks 52 are located on opposite sides of semi-cylindrical wall 54, and are attached by welding or other suitable means. It may be seen from FIG. 5 that mounting hooks 52 extend outward beyond funnel lip 62 to enable funnel 50 to engage with chute pins 22 (not shown in FIG. 5). A handle 68 may also be included on funnel assembly 50 and may be located on rear funnel wall 56. Handle 68 is useful for handling funnel 50 when aligning mounting hooks 52 with chute pins 22 on main chute 16 or mounting brackets 42 on catch basin 30.

Funnel assembly 50 includes a drain opening 70 formed in the bottom of semi-cylindrical funnel wall 54. A drain pipe 72 is attached to drain opening 70 for receiving cleaning water flowing into funnel 50. Drain pipe 72 preferably includes an elbow 74 for angling the drain pipe exit 76 toward basin 30 when funnel 50 is mounted on main chute 16. Drain pipe exit 76 includes a hose connector fitting 78, such as a camlock fitting, threaded hose fitting, or any of the other types of hose fittings commonly known in the art. As illustrated in FIG. 1, a drain hose 80 has a first end 82 connectable to drain pipe 72, and a second end 84 that is disposed within catch basin 30. It will be apparent that cleaning liquid is able to pass from main chute 16, into funnel 50, through drain pipe 72 and drain hose 80, and into catch basin 30.

The system 10 of the invention also makes provision for the convenient cleaning of auxiliary chute 18 by providing an auxiliary chute support arrangement 88. As illustrated in FIGS. 3 and 4, auxiliary chute support arrangement 88 includes auxiliary chute support rods 90, which are stored in storage tubes 92 located on the inner surface of lid 36. Support rods 90 may be retained in storage tubes 92 by frictional fit or by other known means. Support rods 90 are constructed from angle iron or other suitable material having an angle cross-section, and each support rod 90 includes an auxiliary chute support pin 94 located at one end. Support pins 94 extend outward at a right angle from the major axis of support rods 90, and are attached to support rods 90 by welding or other suitable means.

Basin 30 includes two pairs of support rod brackets located at two opposed inner corners of near sidewall 32. Each pair of support rod brackets includes an upper support rod bracket 96 and a lower support rod bracket 98. An angle-shaped hole 100 is formed in-line through each support rod bracket 96, 98, so that a support rod 90 can be slid into angle-shaped hole 100 and maintained in an upright position. Because hole 100 is angle-shaped, rather than round, support rods 90 will not rotate when inserted in holes 100. Support rods 90 are inserted in holes 100 in the configuration illustrated in FIG. 3, so that support pins 94 face outward in opposite directions from each other. As illustrated in FIG. 1, an auxiliary chute 18 may be hooked-on to support pins 94 and held with its mating end 24 adjacent to basin 30, so that when auxiliary chute 18 is washed, the runoff will flow directly into basin 30.

In addition, it should be noted that bottom 34 of catch basin 30 has a downward slope from front wall 31 to rear wall 33, and from far sidewall 32 to near sidewall 32, so that water will flow toward a drain valve 110 located at a rear corner 112 of catch basin 30. Drain valve 110 includes a handle 114, which may be actuated by pulling outward, as indicated by arrow 116 in FIG. 3 for opening drain valve 110 to empty catch basin 30. Of course, it is only desirable to drain the liquid from catch basin 30 at a suitable location where the contents can be properly treated. Accordingly, drain valve 110 must be of a type that is suitably secure from opening when truck 12 travels over bumps, or the like, but otherwise, any type of drain valve known in the art may be used as drain valve 110.

In use, truck 12 travels to a job site to deliver an amount of concrete or other material. At this point catch basin 30 should be empty of liquid and secured by main latch 48 and funnel latch 49 (if installed), as illustrated in FIG. 2. Following pouring of the concrete, when it is time to clean dispensing elements 14, such as hopper 15, main chute 16, and auxiliary chute 18, lid 36 of catch basin 30 is opened and auxiliary chute support rods 90 are inserted into holes 100 in support rod brackets 96, 98. Auxiliary chute 18 is then detached from main chute 16, and mounted on support rods 90 by engaging chute attachment hooks 26 with support pins 94. Funnel assembly 50 is then lifted off mounting brackets 42 and mated to free end 20 of main chute 16 by engaging mounting hooks 52 with chute pins 22. First end 82 of drain hose 80 is attached to hose connector fitting 78 on drain pipe 72, and second end 84 of drain hose 80 is disposed in the interior of catch basin 30. System 10 is now configured as illustrated in FIG. 1.

The operator obtains a water hose 120 having an available source of water or other cleaning liquid. The source of water may be city water or well water provided by the contractor at the job site. Alternatively, truck 12 may be fitted with a water tank (not shown) containing a source of water that can be pressurized with a hand pump (not shown), or by other means, as is known in the art. This makes the entire cleaning process self-contained and not reliant on the requirement that there be a nearby source of water. The operator uses the water from water hose 120 to wash the residual concrete from hopper 15 and main chute 16. The combined mixture of water and concrete residue flows into funnel assembly 50, down drain pipe 72, through drain hose 80, and into catch basin 30. After hopper 15 and main chute 16 have been cleaned satisfactorily, auxiliary chute 18 is also cleaned using water from water hose 120. Following cleaning, auxiliary chute 18 is removed from support pins 94 and stowed, drain hose 80 is removed from drain pipe 72, and funnel assembly 50 is removed from main chute 16, replaced on mounting brackets 42, and latched in place using funnel latch 49 (if installed). Support rods 90 are returned to storage tubes 92, and lid 36 is closed and main latch 48 is latched. Truck 12 then returns to the concrete facility and catch basin 30 is drained by opening drain valve 110 by turning handle 114. The contents of catch basin 30 are either properly disposed of, or, preferably, recycled, and catch basin 30 is rinsed out and ready for reuse.

From the foregoing it should be apparent that the system 10 of the invention sets forth a method and apparatus for cleaning the dispensing elements of mixing trucks that have a number of advantages over the prior art. The present invention does not require pumps for operation, and does not require any heavy lifting or manual carrying of waste runoff, but, instead, merely relies on gravity for transporting the runoff to the catch basin. In addition, the invention provides a simple and efficient system for containing and properly disposing of or recycling the residual material.

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Combinations of the above embodiments, and other embodiments not specifically described herein will be apparent to those of skill in the art upon reviewing the foregoing disclosure. The scope of the invention should properly be determined with reference to the appended claims, along with the full range of equivalents to which such claims are entitled.

The invention claimed is:

1. A method for cleaning a material residue from the dispensing elements of a truck following dispensing of a material along at least a main chute, the method comprising:
mounting a catch basin on the truck;
attaching a funnel to the main chute;
connecting a hose between said funnel and said catch basin; and
washing the main chute with liquid, whereby the liquid washes the material residue from the main chute, into said funnel, through said hose, and into said catch basin.

2. The method of claim 1, wherein the dispensing elements include a detachable auxiliary chute, and further including the steps of:
mounting the auxiliary chute on said catch basin; and
washing material residue from the auxiliary chute into said catch basin.

3. The method of claim 2, further including the steps of:
providing a pair of support rods, said support rods having pins extending at right angles therefrom;
positioning said support rods in an upright position on said catch basin; and
mounting the auxiliary chute on said pins of said support rods.

4. The method of claim 1, wherein the dispensing elements include a hopper, and further including the step of washing the hopper with liquid when washing the main chute with liquid.

5. The method of claim 1, further including the step of:
removing said funnel from the main chute and mounting said funnel on said catch basin for transport.

6. The method of claim 5, further including the steps of:
providing a lid on said catch basin; and
closing and latching said lid for transport.

7. The method of claim 6, further including the steps of:
transporting the truck with said catch basin to a disposal location;
providing a drain valve on said catch basin; and
opening said drain valve to drain said catch basin for disposal of said material residue.

8. An apparatus for facilitating the cleaning of residue from the dispensing elements of a mixing truck, the dispensing elements including at least a main chute, said apparatus comprising:
a catch basin mounted on the truck for receiving runoff from the cleaning of the dispensing elements;
a funnel attachable to the main chute for receiving runoff from the main chute; and
a hose having a first end connected to said funnel and a second end disposed in said catch basin, whereby said funnel may be mounted on a free end the main chute, and runoff from washing the main chute flows into said funnel, through said hose, and into said catch basin.

9. The apparatus of claim 8, further including a gasket provided on said funnel for contacting the free end of the main chute for preventing the leakage of runoff between the main chute and said funnel.

10. The apparatus of claim 8, further including a pair of hooks provided on said funnel for use in mounting said funnel to the free end of the main chute.

11. The apparatus of claim 10, wherein said catch basin includes a pair of mounting brackets, said mounting brackets having horizontally-disposed funnel support pins for mounting said funnel on said catch basin for transport.

12. The apparatus of claim 8, wherein said catch basin includes a front wall, a pair of side walls, a rear wall, and a bottom, wherein a drain valve is located on said bottom, and said bottom slopes toward said drain valve to facilitate draining of said catch basin.

13. The apparatus of claim 8, wherein the dispensing elements of the truck include a detachable auxiliary chute having a pair of hooks on a first end thereof, said apparatus further including an auxiliary chute support arrangement for mounting the auxiliary chute on said catch basin, whereby runoff from washing of the auxiliary chute will flow into said catch basin.

14. The apparatus of claim 13, wherein said auxiliary chute support arrangement includes a pair of support rods positionable in an upright position on said catch basin, said support rods having pins extending at right angles therefrom for engaging with the hooks on the auxiliary chute.

15. An apparatus for facilitating the cleaning of residual concrete from the dispensing elements of a concrete mixing truck, the dispensing elements including at least a main chute having a free end with a pair of chute pins extending therefrom, said apparatus comprising:
a catch basin mounted on the truck for receiving runoff from the cleaning of the dispensing elements;
a funnel mountable on the chute pins of the main chute for receiving runoff from the main chute; and
a hose having a first end connected to said funnel and a second end disposed in said catch basin, whereby said funnel may be mounted on the free end the main chute by mounting on the chute pins, and runoff from washing the main chute flows into said funnel, through said hose, and into said catch basin.

16. The apparatus of claim 15, further including a pair of hooks provided on said funnel for use in mounting said funnel on the chute pins on the free end of the main chute.

17. The apparatus of claim 16, wherein said catch basin includes a pair of mounting brackets, said mounting brackets having horizontally-disposed funnel support pins for mounting said funnel on said catch basin for transport.

18. The apparatus of claim 15, wherein said catch basin includes a front wall, a pair of side walls, a rear wall, and a bottom, wherein a drain valve is located on said bottom, and said bottom slopes toward said drain valve to facilitate draining of said catch basin.

19. The apparatus of claim 15, wherein the dispensing elements of the truck include a detachable auxiliary chute having a pair of hooks on a first end thereof, said apparatus further including an auxiliary chute support arrangement for mounting the auxiliary chute on said catch basin, whereby runoff from washing of the auxiliary chute will flow into said catch basin.

20. The apparatus of claim 19, wherein said auxiliary chute support arrangement includes a pair of support rods positionable in an upright position on said catch basin, said support rods having pins extending at right angles therefrom for engaging with the hooks on the auxiliary chute.
